(19) United States
(12) Patent Application Publication
(10) Pub. No.: US 2026/0200253 A1
(43) Pub. Date: Jul. 16, 2026

(54) WINDING DEVICE AND RECORDING APPARATUS

(71) Applicant: SEIKO EPSON CORPORATION, Tokyo (JP)

(72) Inventors: Masahiro HAYASHIBE, SHIOJIRI-SHI (JP); Ryuichi SATO, SHIOJIRI-SHI (JP)

(21) Appl. No.: 19/442,435

(22) Filed: Jan. 7, 2026

(30) Foreign Application Priority Data
Jan. 10, 2025 (JP) 2025-004213

(51) Int. Cl. B41J 15/16; B41J 3/407

(52) U.S. Cl. CPC B41J 15/16; B41J 3/4078

(57) ABSTRACT

A winding device of the present disclosure includes a rotating shaft member, a plurality of first displacement units having one ends attached to the shaft member and capable of changing the length in the radial direction (a direction orthogonal to the X axis) of the shaft member, and an outer circumferential member attached to the other ends of the plurality of first displacement units, a long member coming into contact with and being wound onto the outer circumferential member.

The present application is based on, and claims priority from JP Application Serial Number 2025-004213, filed January 10, 2025, the disclosure of which is hereby incorporated by reference herein in its entirety.

### BACKGROUND

### 1. Technical Field

The present disclosure relates to a winding device and a recording apparatus.

### 2. Related Art

An example of the related art of the device of this type is disclosed in JP-A-2007-191301. JP-A-2007-191301 discloses the following.

When air pressure is supplied to a cylinder chamber via a check valve before a printing long member such as fiber thread or paper is wound onto a core tube, a piston overcomes the force of a spring and moves to the inner diameter side of a main body. Accordingly, a lug integrated with the piston is retracted from the outer surface of the main body and the air pressure is maintained in the cylinder chamber by the check valve. Accordingly, a shaft can be inserted into the core tube.

After the shaft is inserted into the core tube, the air pressure in the cylinder chamber is released by opening the check valve. Accordingly, the lug integrated with the piston is protruded from the outer surface of the main body by the spring and comes into contact with the inner surface of the core tube and a holding shaft holds the core tube.

When the winding of the printing long member is completed in a state in which the shaft and the core tube are held, the shaft can be pulled out from the core tube by performing the same operation as explained above. The core tube is also called paper tube.

JP-A-2007-191301 is an example of the related art.

JP-A-2007-191301 discloses a configuration in which the printing long member is wound onto the core tube. However, there is a problem in that a core tube is required every time the printing long member is wound, which increases production cost.

There is also a problem in that waste increases because members that become unnecessary after use, such as an adhesive sheet used for sticking and conveying the printing long member and release paper peeled from the adhesive sheet, are discarded for each core tube after being wound onto the core tube.

### SUMMARY

In order to solve the problems described above, a winding device according to the present disclosure includes: a rotating shaft member; a plurality of first displacement units having one ends attached to the shaft member and capable of changing length in a radial direction of the shaft member; and an outer circumferential member attached to other ends of the plurality of first displacement units, a long member being wound onto the outer circumferential member.

A recording apparatus according to the present disclosure includes: a letting-out unit configured to let out a long member wound in a roll shape in a conveyance direction; a recording unit configured to perform recording on the long member; and a winding device located further downstream than the recording unit in the conveyance direction and configured to wind the long member. The winding device is a winding device described in any one of first to sixteenth aspects explained below.

### BRIEF DESCRIPTION OF THE DRAWINGS

FIG. 1 is a side schematic view of a schematic configuration of a recording apparatus including a winding device in a first embodiment.

FIG. 2 is a main part side schematic view illustrating action of the winding device in the first embodiment.

FIG. 3 is a main part perspective view of the winding device in the first embodiment.

FIG. 4 is a main part side schematic view of a winding device in a second embodiment.

FIG. 5 is a main part side schematic view illustrating action of a winding device in a third embodiment.

FIG. 6 is a main part side schematic view illustrating action of a winding device in a fourth embodiment.

FIG. 7 is a main part side schematic view illustrating action of a winding device in a fifth embodiment.

FIG. 8 is a main part side schematic view illustrating action of a winding device in a sixth embodiment.

FIG. 9 is a main part side schematic view illustrating action of a winding device in a seventh embodiment.

### DESCRIPTION OF EMBODIMENTS

First, the present disclosure is schematically explained below.

In order to solve the problems described above, a winding device according to a first aspect of the present disclosure includes: a rotating shaft member; a plurality of first displacement units having one ends attached to the shaft member and capable of changing length in a radial direction of the shaft member; and an outer circumferential member attached to other ends of the plurality of first displacement units, a long member being wound onto the outer circumferential member.

According to this aspect, the winding device includes the plurality of first displacement units having the one ends attached to the shaft member and capable of changing the length in the radial direction of the shaft member. The winding device further includes the outer circumferential member attached to the other ends of the plurality of first displacement units, the long member being wound onto the outer circumferential member.

Accordingly, by, after the winding of the long member ends, changing the outer circumferential member, onto which the long member is wound, to a direction in which the length of the first displacement unit decreases, it is possible to separate the outer circumferential member from the wound long member. Thus, it is possible to wind the long member with the outer circumferential member without requiring a core tube as in the related art and, further, it is possible to easily detach the wound long member from the winding device. In particular, when the long member to be wound is of a type having an adhesive surface, the obtained effect is significant.

From the above, according to this aspect, it is possible to reduce production cost because the core tube is unnecessary and, further, it is possible to suppress an increase in an amount of waste.

A winding device according to a second aspect of the present disclosure is an aspect dependent from the first aspect, the winding device including a fixing member capable of switching a fixed state in which a distal end of the long member is fixed and a released state in which the distal end is released.

According to this aspect, the winding device includes the fixing member capable of switching the fixed state in which the distal end of the long member is fixed and the released state in which the distal end is released. Accordingly, work of sticking the distal end of the long member with a tape or the like as in the related art is unnecessary, which is convenient for a user.

When the wound long member is separated from the outer circumferential member, the fixed state is switched to the released state by releasing the fixing of the distal end of the long member by the fixing member. Accordingly, it is possible to more easily detach the wound long member from the winding device.

A winding device according to a third aspect of the present disclosure is an aspect dependent from the second aspect, the winding device including a second displacement unit disposed between the plurality of first displacement units in a circumferential direction of the shaft member, having one end attached to the shaft member, and capable of changing length in the radial direction of the shaft member, wherein the fixing member is attached to another end of the second displacement unit and sandwiches and fixes the distal end of the long member with a pair of the fixing member and the outer circumferential member when length in the radial direction of the second displacement unit is changed and the fixing member approaches the outer circumferential member.

According to this aspect, the second displacement unit is disposed between the plurality of first displacement units in the circumferential direction of the shaft member. The second displacement unit has the one end attached to the shaft member and is capable of changing the length in the radial direction of the shaft member. The fixing member is attached to the other end of the second displacement unit.

The fixing member is configured to sandwich and fix the distal end of the long member with the pair of the fixing member and the outer circumferential member when the length in the radial direction of the second displacement unit is changed and the fixing member approaches the outer circumferential member. The fixing member is configured to release the distal end of the long member when the length in the radial direction of the second displacement unit is changed and the fixing member separates from the outer circumferential member.

Accordingly, the distal end of the long member can be fixed and released with a simple structure of the pair of the fixing member and the outer circumferential member.

A winding device according to a fourth aspect of the present disclosure is an aspect dependent from the third aspect, wherein the fixing member sandwiches and fixes the distal end of the long member with the pair of the fixing member and the outer circumferential member by, when the length in the radial direction of the second displacement unit is changed, being displaced to a same position as a position where the long member is wound onto the outer circumferential member in the radial direction.

According to this aspect, the fixing member is displaced to, via the second displacement unit, the same position as the position where the long member is wound onto the outer circumferential member in the radial direction. The fixing member is configured to sandwich and fix the distal end of the long member with the pair of the fixing member and the outer circumferential member according to the displacement of the fixing member. That is, the distal end of the long member is sandwiched and fixed by a pair of a side surface of the fixing member and a side surface of the outer circumferential member.

Accordingly, it is possible to fix and release the distal end of the long member with a simple structure of the pair of the side surface of the fixing member and the side surface of the outer circumferential member.

A winding device according to a fifth aspect of the present disclosure is an aspect dependent from the third aspect, wherein the fixing member sandwiches and fixes the distal end of the long member with the pair of the fixing member and the outer circumferential member by, when the length in the radial direction of the second displacement unit is changed, being displaced to a position further on an inner side than a position where the long member is wound onto the outer circumferential member in the radial direction.

According to this aspect, the fixing member is displaced to, via the second displacement unit, when the position in the radial direction is changed, the position further on the inner side than the position where the long member is wound onto the outer circumferential member in the radial direction. The fixing member is configured to sandwich and fix the distal end of the long member with the pair of the fixing member and the outer circumferential member according to the displacement of the fixing member. That is, the distal end of the long member is sandwiched and fixed by a pair of the outer surface of the fixing member and the inner surface of the outer circumferential member.

Accordingly, it is possible to fix and release the distal end of the long member with a simple structure of the pair of the outer surface of the fixing member and the inner surface of the outer circumferential member.

A winding device according to a sixth aspect of the present disclosure is an aspect dependent from the second aspect, wherein the outer circumferential members adjacent to each other in a circumferential direction of the shaft member are a first outer circumferential member and a second outer circumferential member, and the fixing member is provided in the first outer circumferential member and is capable of switching the distal end of the long member to a fixed state in which the fixing member comes into contact with the second outer circumferential member to sandwich and fix the distal end of the long member with a pair of the fixing member and the second outer circumferential member and a released state in which the fixing member separates from the second outer circumferential member to release the fixing of the distal end of the long member.

Here, "contact" in "the fixing member comes into contact with the second outer circumferential member to" means that the fixing member comes into contact with the second outer circumferential member in a state in which the distal end of the long member is sandwiched between the fixing member and the second outer circumferential member.

According to this aspect, the fixing member is provided on the first outer circumferential member. The fixing member is configured to be capable of switching the distal end of the long member to the fixed state in which the fixing member comes into contact with the second outer circumferential member to sandwich and fix the distal end of the long member with the pair of the fixing member and the second outer circumferential member and the released state in which the fixing member separates from the second outer circumferential member to release the fixing of the distal end of the long member.

Accordingly, it is possible to switch the fixed state and the released state for the distal end of the long member with a simple structure of switching the fixing member provided in the first outer circumferential member to a state of coming into contact with the second outer circumferential member and a state of separating from the second outer circumferential member. Thus, it is possible to fix and release the distal end of the long member.

A winding device according to a seventh aspect of the present disclosure is an aspect dependent from the sixth aspect, wherein the fixed state and the released state of the fixing member are switched when one end of the fixing member is attached to the first outer circumferential member as a turning fulcrum and another end turns as a free end.

According to this aspect, one end of the fixing member is attached to the first outer circumferential member as the turning fulcrum. Further, the fixing member is configured such that the fixed state and the released state are switched when the other end turns as the free end.

Accordingly, it is possible to fix and release the distal end of the long member with a simple structure of turning the fixing member with one end as the turning fulcrum.

A winding device according to an eighth aspect of the present disclosure is an aspect dependent from the sixth aspect, wherein the fixing member has one end attached to the first outer circumferential member and another end including a facing section facing an inner surface of the second outer circumferential member and is switched from the released state to the fixed state by increasing length in the radial direction of the first displacement unit, to which the first outer circumferential member is attached, and bringing the facing section close to the inner surface of the second outer circumferential member in a state in which length in the radial direction of the first displacement unit, to which the second outer circumferential member is attached, is increased.

According to this aspect, one end of the fixing member is attached to the first outer circumferential member and the other end of the fixing member includes the facing section facing the inner surface of the second outer circumferential member. The fixing member is configured to switch the released state to the fixed state by increasing the length in the radial direction of the first displacement unit, to which the first outer circumferential member is attached, and bringing the facing section close to the inner surface of the second outer circumferential member in the state in which the length in the radial direction of the first displacement unit, to which the second outer circumferential member is attached, is increased.

Accordingly, it is possible to switch the distal end of the long member from the released state to the fixed state with a simple structure of displacing the facing section of the fixing member with the first displacement unit to come into contact with the inner surface of the second outer circumferential member.

A winding device according to a ninth aspect of the present disclosure is an aspect dependent from the second aspect, the winding device including a second displacement unit disposed between the plurality of first displacement units in a circumferential direction of the shaft member, having one end attached to the shaft member and another end attached to the fixing member, and capable of changing length in the radial direction of the shaft member, wherein the fixing member sandwiches and fixes the distal end of the long member with a pair of the fixing member and the shaft member when the length in the radial direction of the second displacement unit is changed and the fixing member approaches the shaft member.

According to this aspect, the second displacement unit is disposed between the plurality of first displacement units in the circumferential direction of the shaft member. The second displacement unit has the one end attached to the shaft member and is capable of changing the length in the radial direction of the shaft member. The fixing member is attached to the other end of the second displacement unit.

The fixing member is configured to sandwich and fix the distal end of the long member with the pair of the fixing member and the shaft member when the length in the radial direction of the second displacement unit is changed and the fixing member approaches the shaft member. The fixing member is configured to release the distal end of the long member when the length in the radial direction of the second displacement unit is changed and the fixing member separates from the shaft member.

Accordingly, it is possible to fix and release the distal end of the long member with a simple structure of the pair of the fixing member and the shaft member.

A winding device according to a tenth aspect of the present disclosure is an aspect dependent from the second aspect, wherein the fixing member is capable of switching the distal end of the long member to a fixed state in which the fixing member moves to a position where the distal end of the long member is sandwiched by a pair of the fixing member and the shaft member and fixes the distal end of the long member and a released state in which the fixing member moves from the sandwiching position to release the fixing of the distal end of the long member.

According to this aspect, the fixing member is configured to be capable of switching the distal end of the long member to the fixed state in which the fixing member moves to the position where the distal end of the long member is sandwiched by the pair of the fixing member and the shaft member and fixes the distal end of the long member and the released state in which the fixing member moves from the sandwiching position to release the fixing of the distal end of the long member.

Accordingly, it is possible to fix and release the distal end of the long member by moving the fixing member to the sandwiching position or moving the fixing member in a direction of retracting from the sandwiching position.

A winding device according to an eleventh aspect of the present disclosure is an aspect dependent from the tenth aspect, wherein the fixing member is switched to the fixed state and the released state when one end of the fixing member is attached to the shaft member as a turning fulcrum and the other end of the fixing member turns as a free end.

According to this aspect, one end of the fixing member is attached to the shaft member as the turning fulcrum. Further, the fixing member is configured to be switched to the fixed state and the released state when the other end turns as the free end.

Accordingly, it is possible to fix and release the distal end of the long member with a simple structure of turning the fixing member with one end as the turning fulcrum.

A winding device according to a twelfth aspect of the present disclosure is an aspect dependent from the tenth aspect, wherein a recess in which the fixing member detachably fits is provided in the shaft member, and the fixing member is switched to the fixed state in which the fixing member moves to a position of fitting in the recess and is fixed and the released state in which the fixing member moves from the fitting position and releases the fixing of the distal end of the long member.

According to this aspect, the fixing member is configured to be switched to the fixed state in which the fixing member moves to the position of fitting in the recess and is fixed and the released state in which the fixing member moves from the fitting position and releases the fixing of the distal end of the long member.

Accordingly, it is possible to fix and release the distal end of the long member by moving the fixing member to the fitting position or moving the fixing member in a direction of retracting from the fitting position.

A winding device according to a thirteenth aspect of the present disclosure is an aspect dependent from the third aspect, wherein the outer circumferential member is in a point contact state or a line contact state with the long member to be wound onto the outer circumferential member.

Note that this aspect can also be dependent from any one of the fourth to ninth aspects.

According to this aspect, the outer circumferential member is configured to come into a point contact state or a line contact state with the long member to be wound onto the outer circumferential member. Accordingly, since a contact area of a portion of the long member in contact with the outer circumferential member is smaller than that in a surface contact state, the outer circumferential member onto which the long member is wound can be easily changed in a reducing direction of the length of the first displacement unit after the winding of the long member ends and, therefore, it is possible to easily separate the outer circumferential member from the wound long member.

A winding device according to a fourteenth aspect of the present disclosure is an aspect dependent from the ninth aspect, wherein the outer circumferential member is in a point contact state or a line contact state with the long member to be wound onto the outer circumferential member.

Note that this aspect can also be dependent from any one of the tenth to twelfth aspects.

According to this aspect, the outer circumferential member is configured to come into a point contact state or a line contact state with the long member to be wound onto the outer circumferential member. Accordingly, since a contact area of a portion of the long member in contact with the outer circumferential member is smaller than that in a surface contact state, the outer circumferential member onto which the long member is wound can be easily changed in a direction of reducing the length of the first displacement unit after the winding of the long member ends and, therefore, it is possible to easily separate the outer circumferential member from the wound long member.

A winding device according to a fifteenth aspect of the present disclosure is an aspect dependent from the second aspect, wherein the outer circumferential member and the fixing member are respectively disposed in a plurality of regions in an axial direction of the shaft member.

Note that this aspect can also be dependent from any one of the third to fourteenth aspects.

According to this aspect, the outer circumferential member and the fixing member are configured to be respectively disposed in the plurality of regions in the axial direction of the shaft member. That is, there is a region where the outer circumferential member and the fixing member are absent in the axial direction of the shaft member. Accordingly, a contact area of the portion of the long member in contact with the outer circumferential member decreases by the region where the outer circumferential member and the fixing member are absent and it is possible to easily separate the outer circumferential member from the wound long member. It is possible to reduce the weight of the winding device.

A winding device according to a sixteenth aspect of the present disclosure is an aspect dependent from the fifteenth aspect, wherein the outer circumferential member disposed in a first region of the plurality of regions and the outer circumferential member disposed in a second region adjacent to the first region in the axial direction of the shaft member do not overlap in a circumferential direction of the shaft member. That is, the outer circumferential member in the first region and the outer circumferential member in the second region are configured to be disposed in a staggered manner.

According to this aspect, the outer circumferential member in the first region and the outer circumferential member in the second region are configured to be disposed in a staggered manner. Accordingly, the long member in a portion floating in the air without being wound onto the outer circumferential member in the first region can be wound onto the outer circumferential member in the second region and, therefore, it is possible to suppress deterioration in winding accuracy.

A recording apparatus according to a seventeenth aspect of the present disclosure includes: a letting-out unit configured to let out a long member wound in a roll shape in a conveyance direction; a recording unit configured to perform recording on the long member; and a winding device located further downstream than the recording unit in the conveyance direction and configured to wind the long member. The winding device is the winding device described in any one of the first to sixteenth aspects.

According to this aspect, the recording apparatus can obtain the same effects as the effects described in any one of the first to sixteenth aspects.

A recording apparatus according to an eighteenth aspect of the present disclosure is an aspect dependent from the seventeenth aspect, wherein the letting-out unit lets out, in the conveyance direction, a roll-shaped long member formed by fabric being stuck to a support member having an adhesive surface, the winding device includes a support member winding device and a fabric winding unit that peel off the fabric from the support member and respectively wind the fabric, and at least the support member winding device is the winding device described in any one of the first to sixteenth aspects.

According to this aspect, at least the support member winding device is the winding device described in any one of the first to sixteenth aspects. Accordingly, even if a long support member having an adhesive surface is wound, the same effects as the effects described in any one of the first to sixteenth aspects can be obtained.

### Embodiments

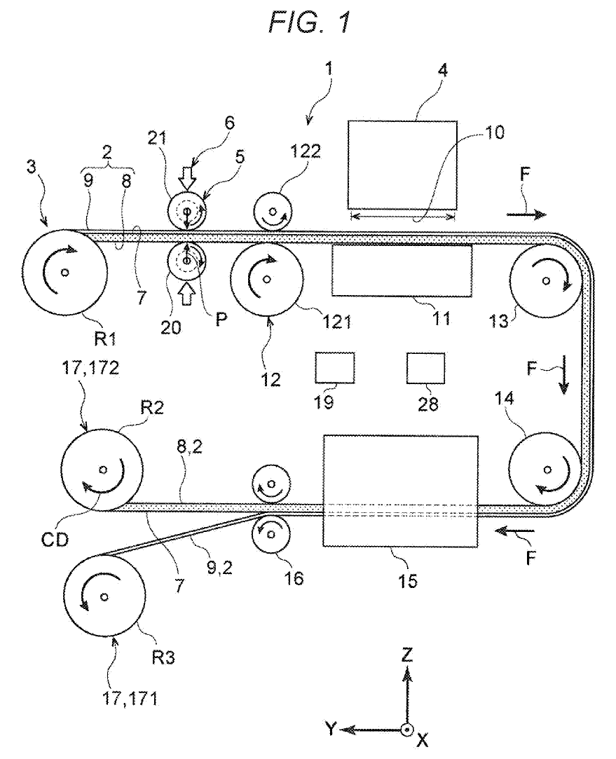

Hereinafter, a winding device and a recording apparatus according to embodiments of the present disclosure are specifically explained with reference to FIGS. 1 to 9. Here, a case in which the recording apparatus is an inkjet printer is explained.

In the following explanation, three axes orthogonal to one another are respectively represented as an X axis, a Y axis, and a Z axis as illustrated in the figures. Directions indicated by arrows of the three axes (X, Y, and Z) are + directions of the directions and the opposite directions of the directions are - directions. A Z-axis direction is equivalent to the vertical direction, that is, a direction in which the gravity acts, a +Z direction indicates the vertically upward direction and a -Z direction indicates the vertically downward direction. An X-axis direction and a Y-axis direction are equivalent to the horizontal direction. A +Y direction indicates the front direction of the recording apparatus and a -Y direction indicates the rear direction of the recording apparatus. A +X direction indicates the right direction of the recording apparatus and a -X direction indicates the left direction of the recording apparatus.

### First Embodiment

As illustrated in FIG. 1, the recording apparatus 1 in the present embodiment includes a letting-out unit 3 that lets out a long member 2 in a conveyance direction F, a recording unit 4, a pressing unit 5, and an adjustment unit 6.

The long member 2 is a roll-shaped long member formed by a sheet-shaped fabric 9 being stuck to a sheet-like support member 8 having an adhesive surface 7. The long member 2 is set in the letting-out unit 3 in a state of a roll body R1. The letting-out unit 3 rotates the roll body R1 to let out the long member 2 in a conveyance direction F.

The recording unit 4 performs recording by ejecting ink onto the fabric 9 of the let-out long member 2 in a recording execution region 10. In the recording execution region 10, the long member 2 is supported by a platen 11.

The pressing unit 5 is located further upstream than the recording unit 4 in the conveyance direction F. The pressing unit 5 is configured to clamp the long member 2 moving in the conveyance direction F and apply a pressing force P to press the long member 2. The pressing unit 5 includes a pair of a driving roller 20 and a pressing roller 21. The driving roller 20 is coupled to a driving unit 19 (FIG. 1) in terms of power and is applied with a rotational driving force. A motor is used as the driving unit 19.

The adjustment unit 6 is configured to be capable of adjusting the pressing force P applied to the long member 2 by the pressing unit 5. In the adjustment unit 6, appropriate magnitude of the pressing force P is grasped and determined in advance by trial production or the like for a plurality of types of the long member 2 assumed to be used. When a user performs operation of specifying a type of the long member 2 via a not-illustrated operation panel or the like, the pressing force P corresponding to the type acts on the long member 2.

As illustrated in FIG. 1, the recording apparatus 1 further includes a conveyance unit 12 that applies a conveyance force to the long member 2 toward the recording unit 4 side, intermediate rollers 13 and 14, a drying processing unit 15, an end roller pair 16, and a winding device 17.

The conveyance unit 12 includes a pair of a conveyance roller 121 that rotates with power being transmitted from a not-illustrated drive source and a driven roller 122 that rotates following the rotation of the conveyance roller 121. The intermediate rollers 13 and 14 are disposed at a position for changing the conveyance direction of the long member 2 and are driven to rotate according to the movement of the long member 2 in the conveyance direction F.

The drying processing unit 15 heats and dries the long member 2 to which the ink is ejected. The end roller 16 clamps the long member 2 and is driven to rotate according to the movement of the long member 2.

In the present embodiment, the winding device 17 includes a fabric winding device 171 and a support member winding device 172.

The fabric winding device 171 winds only the fabric 9 to form a roll body R3. The support member winding device 172 is disposed at a position separated from the fabric winding device 171 and winds only the support member 8 to form a roll body R2. That is, in a state in which the long member 2 is clamped by the end roller 16, since the fabric winding device 171 winds only the fabric 9 and the support member winding device 172 winds only the support member 8, the fabric 9 and the support member 8 are peeled.

### Winding device

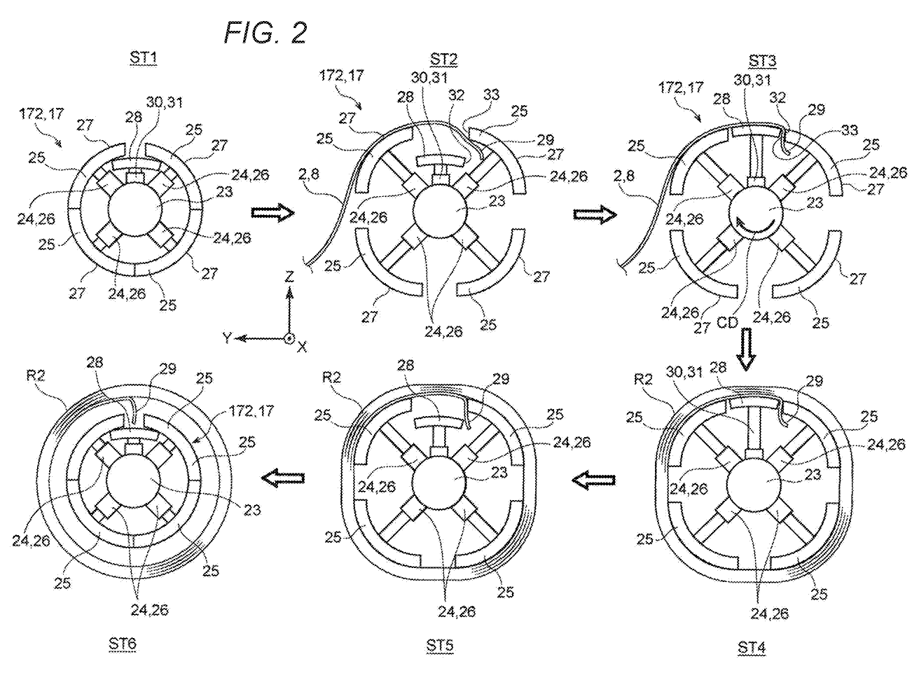

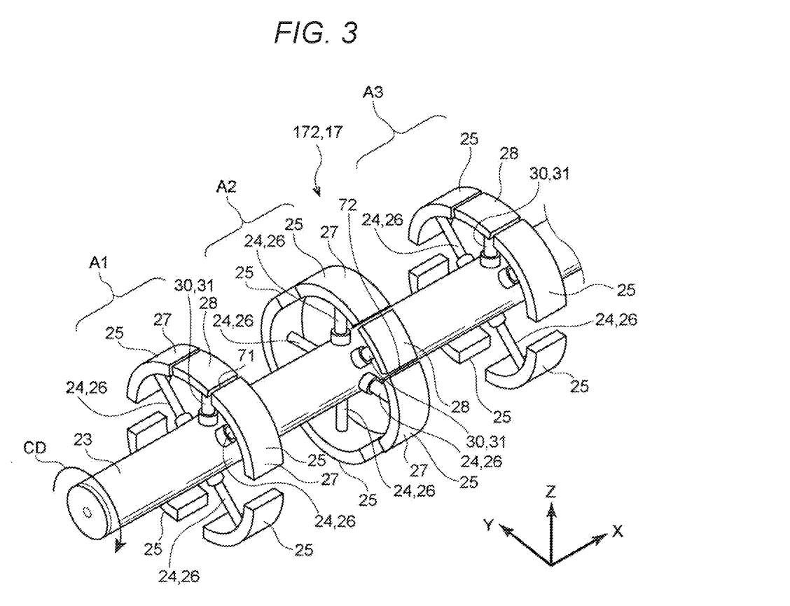

As illustrated in FIGS. 2 and 3, in the present embodiment, the support member winding device 172 of the winding device 17 includes a shaft member 23 that rotates in axial rotation CD, first displacement units 24, and outer circumferential members 25. The shaft member 23 is long in the X-axis direction. Both end portions thereof are supported by not-illustrated bearings. Rotational power is transmitted to the shaft member 23 from a not-illustrated drive source and the shaft member 23 rotates in the axial rotation CD.

The first displacement unit 24 has one end attached to the shaft member 23 and is capable of changing the length in the radial direction (a direction orthogonal to the X axis) of the shaft member 23. A plurality of, here, four first displacement units 24 are provided. In the present embodiment, the first displacement units 24 are configured to change the length in the radial direction of the shaft member 23 with cylinders 26 that use air or oil as power fluid. Adoption of the cylinders 26 as the first displacement units 24 is an example. The first displacement units 24 are not limited thereto and may be anything that can change the length in the radial direction of the shaft member 23, such as a link mechanism.

The outer circumferential members 25 are attached to the other ends of the four first displacement units 24. The long member 2 comes into contact with and is wound onto outer surfaces 27 of the outer circumferential member 25.

The support member winding device 172 includes a fixing member 28. The fixing member 28 is configured to be capable of switching a fixed state (a state ST3 and a state ST4 in FIG. 2) in which a distal end 29 of the long member 2 is fixed and a released state (a state ST5 and a state ST6 in FIG. 2) in which the distal end 29 is released.

In the present embodiment, a second displacement unit 30 is disposed in one place among the four first displacement units 24, 24, 24, and 24 in the circumferential direction of the shaft member 23 (the same direction as the axial rotation CD). The second displacement unit 30 has one end attached to the shaft member 23 and is configured to be capable of changing the length in the radial direction (the direction orthogonal to the X axis) of the shaft member 23. In the present embodiment, the second displacement unit 30 is also configured to be capable of changing the length in the radial direction (the direction orthogonal to the X axis) of the shaft member 23 with cylinder 31 that uses air or oil.

The fixing member 28 is attached to the other end of the second displacement unit 30. The fixing member 28 is configured to sandwich and fix the distal end 29 of the long member 2 with a pair of the fixing member 28 and the outer circumferential member 25 when the length in the radial direction (the direction orthogonal to the X axis) of the second displacement unit 30 is changed and the fixing member 28 approaches the outer circumferential member 25.

In the present embodiment, as indicated by the state ST3 and the state ST4 in FIG. 2, the fixing member 28 is configured to be displaced to the same position as an outer surface 27, which is a position where the long member 2 is wound onto the outer circumferential member 25, in the radial direction (the direction orthogonal to the X axis) when the length in the radial direction (the direction orthogonal to the X axis) of the second displacement unit 30 is changed.

The fixing member 28 is configured to sandwich and fix the distal end 29 of the long member 2 with the pair of the fixing member 28 and the outer circumferential member 25 when the fixing member 28 is displaced to the same position as the outer surface 27 of the outer circumferential member 25. That is, the fixing member 28 is configured sandwich and fix the distal end 29 of the long member 2 with a pair of a side surface 32 of the fixing member 28 and a side surface 33 of the outer circumferential member 25.

A state ST1 in FIG. 2 indicates a state in which the length of the first displacement unit 24 and the length of the second displacement unit 30 are the shortest. A state ST2 in FIG. 2 indicates a state in which the length of the first displacement unit 24 is changed to the longest state while the length of the second displacement unit 30 remaining in the shortest state.

In the present embodiment, as illustrated in FIG. 3, outer circumferential members 25 and fixing members 28 are respectively disposed in a plurality of regions in the axial direction (the X-axis direction) of the shaft member 23. That is, sets of the outer circumferential members 25 and the fixing members 28 are respectively disposed in a first region A1, a second region A2, a third region A3, a fourth region A4, and the like. In FIG. 3, illustration of the fourth region A4 and subsequent regions is omitted.

Further, the outer circumferential members 25 disposed in the first region A1 and the outer circumferential members 25 disposed in the second region A2 adjacent to the first region A1 are disposed not to overlap in the circumferential direction of the shaft member 23 (the same direction as the axial rotation CD). In other words, the outer circumferential members 25 in the first region A1 and the outer circumferential members 25 in the second region A2 are disposed in a staggered manner. Similarly, the outer circumferential members 25 in the second region A2 and the outer circumferential members 25 in the third region A3 are disposed in a staggered manner. The outer circumferential members 25 in the third region A3 and the outer circumferential members 25 in the fourth region A4 are disposed in a staggered manner. Similarly, the subsequent outer circumferential members 25 are disposed in a staggered manner.

Operations of the letting-out unit 3, the pressing unit 5, the conveyance unit 12, the recording unit 4, the drying processing unit 15, the fabric winding device 171, and the support member winding device 172 are performed by a control unit 28 (FIG. 1). The control unit 28 includes a CPU, a flash ROM, and a RAM. The CPU performs various kinds of arithmetic processing according to programs stored in the flash ROM and controls an operation of the entire recording apparatus 1. The flash ROM, which is an example of storage means, is a readable and writable nonvolatile memory. The RAM, which is an example of storage means, temporarily stores various information.

### Explanation of action of the first embodiment

Subsequently, action of the first embodiment is explained with reference to FIG. 2.

(1) First, the support member winding device 172 is changed from the state ST1 to the state ST2 in FIG. 2. That is, the length of the first displacement unit 24 is changed to the longest state while the length of the second displacement unit 30 remaining the shortest state.

(2) Subsequently, the distal end 29 of the long member 2, that is, the distal end 29 of the support member 8 is located in a region between the side surface 32 of the fixing member 28 and the side surface 33 of the outer circumferential member 25 (the state ST2).

(3) In this state, the fixing member 28 is displaced to the same position as the outer surface 27 of the outer circumferential member 25 by the second displacement unit 30 (the state ST3). Accordingly, the distal end 29 of the long member 2 is sandwiched and fixed by a pair of the side surface 32 of the fixing member 28 and the side surface 33 of the outer circumferential member 25 and comes into a fixed state.

In the present embodiment, as illustrated in FIG. 3, the outer circumferential members 25 in the first region A1 and the outer circumferential members 25 in the second region A2 are disposed in a staggered manner. For that reason, at the distal end 29 of the long member 2, a position 71 fixed by the fixing member 28 in the first region A1 and a position 72 fixed by the fixing member 28 in the second region A2 are shifted in the circumferential direction of the shaft member 23. Thus, the distal end 29 of the long member 2 is subjected to slitting and cutting processing and fixed to the positions 71 and 72.

(4) Subsequently, the shaft member 23 of the support member winding device 172 is rotated in the axial rotation CD. By this rotation, the long member 2 comes into contact with and is wound onto the outer surfaces 27, 27, 27, ... of the outer circumferential members 25, 25, 25, ... to form the roll body R2 (the state ST4).

(5) Subsequently, the length of the second displacement unit 30 is reduced to pull back the fixing member 28 to the shaft member 23 side and the fixed state of the distal end 29 is switched to the released state (the state ST5).

(6) Subsequently, the length of the first displacement units 24 is reduced to pull back the outer circumferential members 25 to the shaft member 23 side (the state ST6). Accordingly, the outer circumferential members 25, 25, 25, ... of the support member winding device 172 are separated from the inner surface of the roll body R2. Finally, the roll body R2 is removed from the support member winding device 172.

### Explanation of effects of the first embodiment

(1) In the present embodiment, the winding device 17 includes a plurality of first displacement units 24 having one ends attached to the shaft member 23 and capable of changing the length in the radial direction (the direction orthogonal to the X axis) of the shaft member 23. The winding device 17 further includes the outer circumferential members 25 attached to the other ends of the plurality of first displacement units 24, the long member 2 coming into contact with and being wound onto the outer circumferential members 25.

Accordingly, by, after the winding of the long member 2 ends, changing the outer circumferential member 25, onto which the long member 2 is wound, in a direction in which the length of the first displacement unit 24 decreases, it is possible to separate the outer circumferential member 25 from the wound long members 2 (R2). Thus, it is possible to wind the long member 2 with the outer circumferential member 25 without requiring the core tube as in the related art and, further, it is possible to easily detach the wound long member 2 from the winding device 17. In particular, when the long member 2 to be wound is of a type having the adhesive surface 7, the obtained effect is significant.

From the above, according to the present embodiment, it is possible to reduce production cost because the core tube is unnecessary and, further, it is possible to suppress an increase in an amount of waste.

(2) In the present embodiment, the winding device 17 includes the fixing member 28 capable of switching the fixed state in which the distal end 29 of the long member 2 is fixed and the released state in which the distal end 29 is released. Accordingly, work of sticking the distal end 29 of the long member 2 with a tape or the like as in the related art is unnecessary, which is convenient for the user.

When the wound long member 2 is separated from the outer circumferential member 25, the fixed state is switched to the released state by releasing the fixing of the distal end 29 of the long member 2 by the fixing member 28. Accordingly, it is possible to more easily detach the wound long member 2 from the winding device 17.

(3) In the present embodiment, the second displacement unit 30 is disposed between the plurality of first displacement units 24 in the circumferential direction of the shaft member 23 (the same direction as the axial rotation CD). The second displacement unit 30 has one end attached to the shaft member 23 and is capable of changing the length in the radial direction of the shaft member 23. The fixing member 28 is attached to the other end of the second displacement unit 30.

The fixing member 28 is configured to sandwich and fix the distal end 29 of the long member 2 with a pair of the fixing member 28 and the outer circumferential member 25 when the length in the radial direction of the second displacement unit 30 is changed and the fixing member 28 approaches the outer circumferential member 25. The fixing member 28 is configured to release the distal end 29 of the long member 2 when the length in the radial direction of the second displacement unit 30 is changed and the fixing member 28 separates from the outer circumferential member 25.

Accordingly, it is possible to fix and release the distal end 29 of the long member 2 with a simple structure of the pair of the fixing member 28 and the outer circumferential member 25.

(4) In the present embodiment, the fixing member 28 is displaced to the same position as a position where the long member 2 is wound onto the outer circumferential member 25 in the radial direction via the second displacement unit 30. The fixing member 28 is configured to sandwich and fix the distal end 29 of the long member 2 with the pair of the fixing member 28 and the outer circumferential member 25 according to the displacement of the fixing member 28. That is, the distal end 29 of the long member 2 is sandwiched and fixed by the pair of the side surface 32 of the fixing member 28 and the side surface 33 of the outer circumferential member 25.

Accordingly, it is possible to fix and release the distal end 29 of the long member 2 with a simple structure of the pair of the side surface 32 of the fixing member 28 and the side surface 33 of the outer circumferential member 25.

(5) In the present embodiment, the outer circumferential members 25 and the fixing members 28 are configured to be respectively disposed in the plurality of regions A1, A2, A3, ... in the axial direction of the shaft member 23 (the X-axis direction). That is, there is a region where the outer circumferential member 25 and the fixing member 28 are absent in the axial direction of the shaft member 23. Accordingly, a contact area of the portion of the long member 2 in contact with the outer circumferential member 25 decreases by the region where the outer circumferential member 25 and the fixing member 28 are absent and it is possible to easily separate the outer circumferential member 25 from the wound long member 2. It is possible to reduce the weight of the winding device 17.

(6) In the present embodiment, the outer circumferential members 25 in the first region A1 and the outer circumferential members 25 in the second region A2 are disposed in a staggered manner. Accordingly, the long member 2 in a portion floating in the air without being wound onto the outer circumferential member 25 in the first region A1 can be wound onto the outer circumferential member 25 in the second region A2 and, therefore, it is possible to suppress deterioration in winding accuracy.

### Second Embodiment

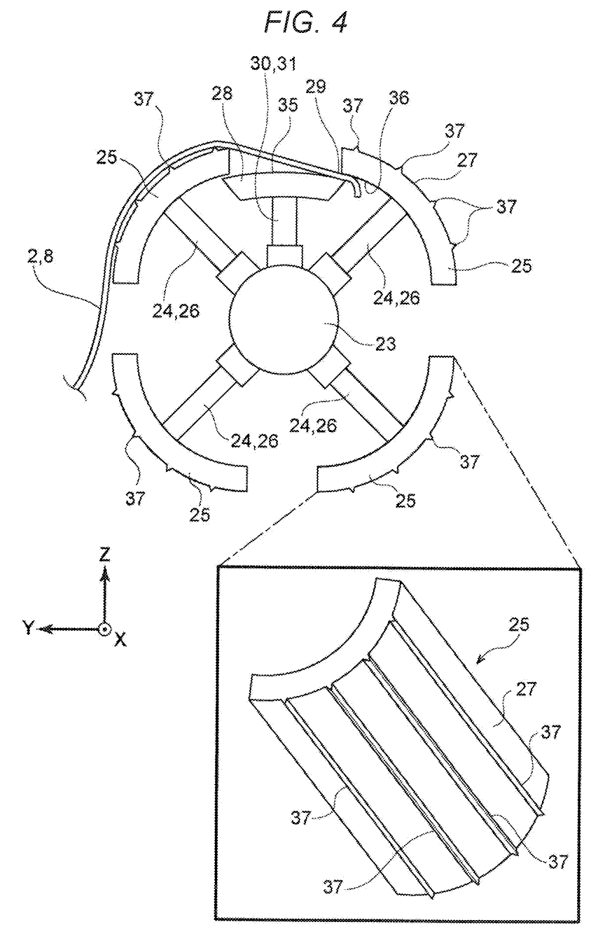

Subsequently, a support member winding device 172 according to a second embodiment is explained with reference to FIG. 4. The same portions as the portions in the first embodiment are denoted by the same reference numerals and signs and explanation of configurations of the portions and effects corresponding to the configurations is omitted.

In the present embodiment, the fixing member 28 is configured to sandwich and fix the distal end 29 of the long member 2 with a pair of the fixing member 28 and the outer circumferential member 25 by being displaced to a position further on the inner side than a position for winding the long member 2 onto the outer circumferential member 25 in the radial direction (the direction orthogonal to the X axis) when the length in the radial direction (the direction orthogonal to the X axis) of the second displacement unit 30 is changed. That is, the fixing member 28 is configured to sandwich and fix the distal end 29 of the long member 2 between the outer surface 35 of the fixing member 28 and the inner surface 36 of the outer circumferential member 25.

In the present embodiment, the outer circumferential member 25 is configured to be in a point contact state or a line contact state with the long member 2 to be wound. Here, the "point contact state or line contact state" does not mean a state in which the entire outer surface 27 of the outer circumferential member 25 is in contact with the long member 2 but means a state in which the outer surface 27 has a part not in contact with the long member 2. In other words, the outer surface 27 of the outer circumferential member 25 is formed in an uneven shape including convex portions and concave portions and the convex portions are in contact with the long member 2 and the concave portions are not in contact with the long member 2.

Here, as illustrated in an enlarged perspective view of FIG. 4, protrusions 37, 37, 37, ... are disposed substantially in parallel on the outer surface 27 of the outer circumferential member 25 to be in contact with the long member 2 in the line contact state.

The configuration of the point contact state or the line contact state of the outer circumferential member 25 with the long member 2 by the protrusions 37 or the like may be applied to the outer surface 27 of the outer circumferential member 25 in the first embodiment or may be applied to other embodiments explained below. The outer circumferential member 25 may be configured to be in a surface contact state rather than the point contact state or the line contact state with the long member 2 to be wound.

### Explanation of effects of the second embodiment

(1) In the present embodiment, the fixing member 28 is displaced to, via the second displacement unit 30, a position further on the inner side than the position for winding the long member 2 onto the outer circumferential member 25 in the radial direction when a position in the radial direction is changed. The fixing member 28 is configured to sandwich and fix the distal end 29 of the long member 2 with a pair of the fixing member 28 and the outer circumferential member 25. That is, the distal end 29 of the long member 2 is sandwiched and fixed by a pair of the outer surface 35 of the fixing member 28 and the inner surface 36 of the outer circumferential member 25.

Accordingly, it is possible to fix and release the distal end 29 of the long member 2 with a simple structure of the pair of the outer surface 35 of the fixing member 28 and the inner surface 36 of the outer circumferential member 25.

(2) In the present embodiment, the outer circumferential member 25 is configured to come into a point contact state or a line contact state with the long member 2 to be wound. Accordingly, since a contact area of a portion of the long member 2 in contact with the outer circumferential member 25 is smaller than that in the surface contact state, the outer circumferential member 25, onto which the long member 2 is wound, can be easily changed in a direction in which the length of the first displacement unit 24 decreases after the winding of the long member 2 ends and, therefore, it is possible to easily separate the outer circumferential member 25 from the wound long members 2 (R2).

### Third Embodiment

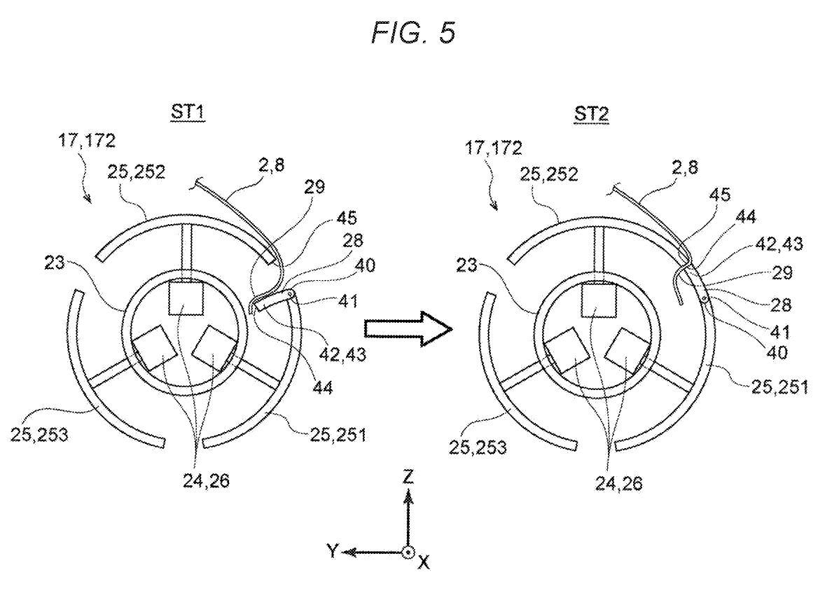

Subsequently, the support member winding device 172 according to a third embodiment is explained with reference to FIG. 5. The same portions as the portions of the first embodiment and the like are denoted by the same reference numerals and signs and explanation of configurations of the portions and effects corresponding to the configurations is omitted.

In the present embodiment, the outer circumferential members 25, 25, and 25 adjacent to one another in the circumferential direction of the shaft member 23 (the same direction as the axial rotation CD) are configured as a first outer circumferential member 251, a second outer circumferential member 252, and a third outer circumferential member 253 as explained below. In the present embodiment, unlike the first embodiment, three outer circumferential members 25 are provided in the regions A1, A2, and A3.

Unlike the first embodiment, the fixing member 28 is provided on the first outer circumferential member 251. The fixing member 28 is configured to be capable of switching the distal end 29 of the long member 2 to a fixed state (a state ST2 in FIG. 5) in which the fixing member 28 comes into contact with the second outer circumferential member 252 to sandwich and fix the distal end 29 of the long member 2 with a pair of the fixing member 28 and the second outer circumferential member 252 and a released state (a state ST1 in FIG. 5) in which the fixing member 28 separates from the second outer circumferential member 252 to release the fixing of the distal end 29 of the long member 2.

Here, "the fixing member 28 comes into contact with the second outer circumferential member 252 to..." means that the fixing member 28 comes into contact with the second outer circumferential member 252 in a state in which the distal end 29 of the long member 2 is sandwiched between the fixing member 28 and the second outer circumferential member 252.

In the present embodiment, one end 40 of the fixing member 28 is attached to the first outer circumferential member 251 as a turning fulcrum 41 by a hinge or the like. The other end 42 of the fixing member 28 is configured to turn as a free end 43 such that the fixed state (the state ST2 in FIG. 5) and the released state (the state ST1 in FIG. 5) are switched. Specifically, the distal end 29 is sandwiched and fixed between the side surface 44 of the other end 42 of the fixing member 28 and the side surface 45 of the adjacent second outer circumferential member 252.

Here, the turning of the fixing member 28 in the direction of switching to the fixed state (the state ST2 in FIG. 5) is manually performed. Note that an electric turning structure using a solenoid or the like may be adopted rather than manually turning the fixing member 28.

### Explanation of action of the fixing member in the third embodiment

(1) The distal end 29 of the long member 2 is caused to enter a region between the side surface 45 of the second outer circumferential member 252 and the fixing member 28 in the released state of the fixing member 28 (the state ST1 in FIG. 5).

(2) Subsequently, the fixing member 28 is turned to sandwich and fix the distal end 29 between the side surface 44 of the other end 42 of the fixing member 28 and the side surface 45 of the second outer circumferential member 252 (the state ST2 in FIG. 5).

(3) Subsequently, the shaft member 23 of the support member winding device 172 is rotated in the axial rotation CD to wind the long member 2.

(4) After the winding ends, first, the length of the first displacement unit 24 of the first outer circumferential member 251 is reduced to move only the first outer circumferential member 251 to the shaft member 23 side. Accordingly, since the fixing member 28 also integrally moves, the distal end 29 of the long member 2 comes into the released state.

(5) Subsequently, the second outer circumferential member 252 and the third outer circumferential member 253 are moved to the shaft member 23 side. Accordingly, the first outer circumferential member 251, the second outer circumferential member 252, and the third outer circumferential member 253 separate from the inner surface of the not-illustrated roll body R2. Finally, the roll body R2 is removed from the support member winding device 172.

### Explanation of effects of the third embodiment

(1) In the present embodiment, the fixing member 28 is provided in the first outer circumferential member 251. The fixing member 28 is configured to be capable of switching the distal end 29 of the long member 2 to a fixed state (a state ST2 in FIG. 5) in which the fixing member 28 comes into contact with the second outer circumferential member 252 to sandwich and fix the distal end 29 of the long member 2 with a pair of the fixing member 28 and the second outer circumferential member 252 and a released state (a state ST1 in FIG. 5) in which the fixing member 28 separates from the second outer circumferential member 252 to release the fixing of the distal end 29 of the long member 2.

Accordingly, it is possible to switch the fixed state and the released state for the distal end 29 of the long member 2 with a simple structure for switching the fixing member 28 provided on the first outer circumferential member 251 to the state of coming into contact with the second outer circumferential member 252 and the state of separating from the second outer circumferential member 252. Thus, it is possible to fix and release the distal end 29 of the long member 2.

(2) In the present embodiment, the one end 40 of the fixing member 28 is attached to the first outer circumferential member 251 as the turning fulcrum 41. Further, the fixing member 28 is configured such that the fixed state and the released state are switched when the other end 42 turns as the free end 43.

Accordingly, it is possible to fix and release the distal end 29 of the long member 2 with a simple structure of turning the fixing member 28 with the one end 40 as the turning fulcrum 41.

### Fourth Embodiment

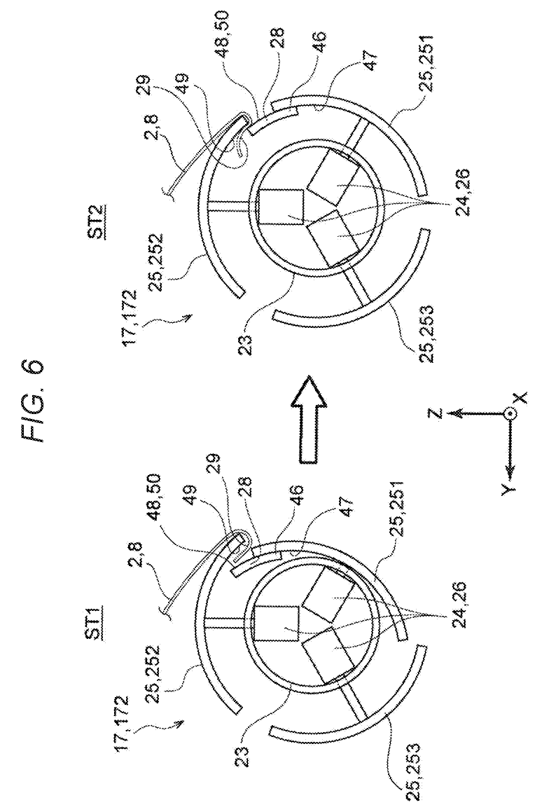

Subsequently, the support member winding device 172 according to a fourth embodiment is explained with reference to FIG. 6. The same portions as the portions of the first embodiment and the like are denoted by the same reference numerals and signs and explanation of configurations of the portions and effects corresponding to the configurations is omitted.

In the present embodiment, one end 46 of the fixing member 28 is attached to the inner surface 47 of the first outer circumferential member 251. The other end 48 of the fixing member 28 includes a facing section 50 facing the inner surface 49 of the second outer circumferential member 252.

The fixing member 28 is configured to be switched from a released state (a state ST1 in FIG. 6) to a fixed state (a state ST2 in FIG. 6) for the distal end 29 of the long member 2 by increasing the length in the radial direction (the direction orthogonal to the X axis) of the first displacement unit 24, to which the first outer circumferential member 251 is attached, and bringing the facing section 50 close to the inner surface 49 of the second outer circumferential member 252 in a state in which the length in the radial direction (the direction orthogonal to the X axis) of the first displacement unit 24, to which the second outer circumferential member 252 is attached, is increased (the state ST1 in FIG. 6).

In the state of ST2 in FIG. 6, by rotating the shaft member 23 of the support member winding device 172 in the axial rotation CD, the long member 2 is wound, and the not-illustrated roll body R2 is formed. Subsequently, first, only the first outer circumferential member 251 is moved to the shaft member 23 side. Accordingly, the distal end 29 of the long member 2 is switched from the fixed state (the state ST2 in FIG. 6) to the released state (the state ST1 in FIG. 6). Subsequently, the second outer circumferential member 252 and the third outer circumferential member 253 are moved to the shaft member 23 side. Accordingly, the first outer circumferential member 251, the second outer circumferential member 252, and the third outer circumferential member 253 are separated from the inner surface of the roll body R2. The roll body R2 can be removed from the support member winding device 172.

In the present embodiment, the one end 46 of the fixing member 28 is attached to the first outer circumferential member 251 and the other end 48 includes the facing section 50 facing the inner surface 49 of the second outer circumferential member 252. The fixing member 28 is configured to be switched from the released state to the fixed state by increasing the length in the radial direction of the first displacement unit 24, to which the first outer circumferential member 251 is attached, and bringing the facing section 50 close to the inner surface 49 of the second outer circumferential member 252 in a state in which the length in the radial direction of the first displacement unit 24, to which the second outer circumferential member 252 is attached, is increased.

Accordingly, it is possible to switch the released state to the fixed state for the distal end 29 of the long member 2 with a simple structure of displacing, with the first displacement unit 24, the facing section 50 of the fixing member 28 to come into contact with the inner surface 49 of the second outer circumferential member 252.

### Fifth Embodiment

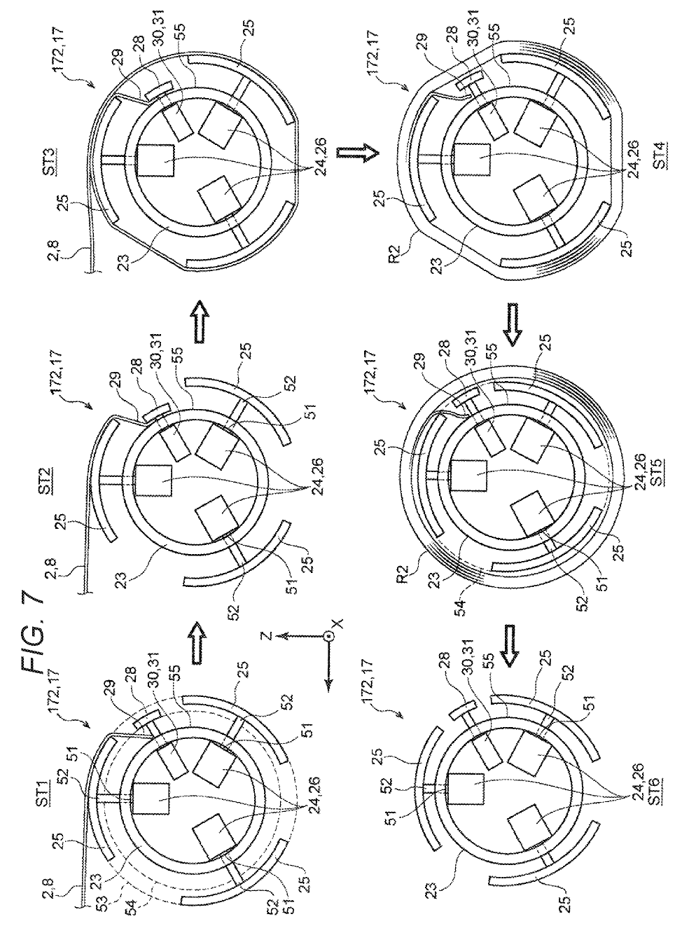

Subsequently, the support member winding device 172 according to a fifth embodiment is explained with reference to FIG. 7. The same portions as the portions of the first embodiment and the like are denoted by the same reference numerals and signs and explanation of configurations of the portions and effects corresponding to the configurations is omitted.

In the present embodiment, the support member winding device 172 includes the second displacement unit 30 disposed between the plurality of first displacement units 24, 24, and 24 in the circumferential direction (the same direction as the axial rotation CD) of the shaft member 23, having one end 51 attached to the shaft member 23 and the other end 52 attached to the fixing member 28, and capable of changing the length in the radial direction (the direction orthogonal to the X axis) of the shaft member 23. The fixing member 28 is configured to sandwich and fix the distal end 29 of the long member 2 with a pair of the fixing member 28 and the shaft member 23 when the length in the radial direction (the direction orthogonal to the X axis) of the second displacement unit 30 is changed and the fixing member 28 approaches the shaft member 23. Specifically, the distal end 29 of the long member 2 is sandwiched and fixed between the outer surface 55 of the shaft member 23 and the fixing member 28.

The fixing member 28 is configured to be displaced by the first displacement unit 24 between a position 53 at the time of the maximum diameter and a position 54 at the time of the minimum diameter. That is, the fixing member 28 winds the long member 2 at the position 53 and is displaced to the position 54 to separate from the inner surface of the not-illustrated roll body R2.

In the present embodiment, as in the second embodiment, the outer circumferential member 25 is configured to be in a point contact state or a line contact state with the long member 2 to be wound. Since explanation of "a point contact state or a line contact state" is the same as the explanation in the second embodiment, the explanation is omitted here.

### Explanation of action of the fifth embodiment

Subsequently, action of the fifth embodiment is explained with reference to FIG. 7.

(1) In a state in which the support member winding device 172 is in a state ST1 in FIG. 7, the distal end 29 of the long member 2, that is, the distal end 29 of the support member 8 is located in a region between the fixing member 28 and the shaft member 23.

(2) Subsequently, the length of the second displacement unit 30 is reduced to displace the fixing member 28 in a direction of approaching the shaft member 23 (a state ST2). Accordingly, the distal end 29 of the long member 2 is sandwiched and fixed between the fixing member 28 and the outer surface 55 of the shaft member 23 and comes into a fixed state.

(3) Subsequently, the shaft member 23 of the support member winding device 172 is rotated in the axial rotation CD. By this rotation, the long member 2 is wound in contact with the outer surfaces 27, 27, and 27 of the outer circumferential members 25, 25, and 25 to be the roll body R2 (states ST3 and ST4).

(4) Subsequently, the length of the second displacement unit 30 is increased to separate the fixing member 28 from the outer surface 55 of the shaft member 23 and the fixed state of the distal end 29 is switched to the released state (the state ST4).

(5) Subsequently, the length of the first displacement units 24 is reduced to pull back the outer circumferential members 25 to the shaft member 23 side. Accordingly, the outer circumferential members 25, 25, and 25 of the support member winding device 172 are separated from the inner surface of the roll body R2 (a state ST5). Finally, the roll body R2 is removed from the support member winding device 172 (a state ST6).

### Explanation of effects of the fifth embodiment

In the present embodiment, the second displacement unit 30 is disposed between the plurality of first displacement units 24 in the circumferential direction of the shaft member 23. The one end 51 of the second displacement unit 30 is attached to the shaft member 23 and the length in the radial direction of the shaft member 23 can be changed. The fixing member 28 is attached to the other end 52 of the second displacement unit 30.

The fixing member 28 is configured to sandwich and fix the distal end 29 of the long member 2 between the fixing member 28 and the outer surface 55 of the shaft member 23 when the length in the radial direction of the second displacement unit 30 is changed and the fixing member 28 approaches the shaft member 23. The fixing member 28 is configured to release the distal end 29 of the long member 2 when the length in the radial direction of the second displacement unit 30 is changed and the fixing member 28 separates from the outer surface 55 of the shaft member 23.

Accordingly, it is possible to fix and release the distal end of the long member with a simple structure of a pair of the fixing member 28 and the shaft member 23.

### Sixth Embodiment

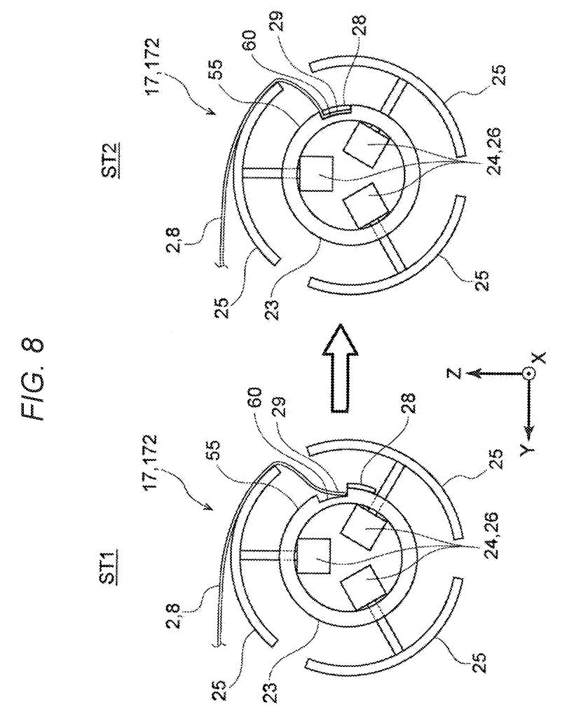

Subsequently, the support member winding device 172 according to a sixth embodiment is explained with reference to FIG. 8. The same portions as the portions of the first embodiment and the like are denoted by the same reference numerals and signs and explanation of configurations of the portions and effects corresponding to the configurations is omitted.

In the present embodiment, unlike the fifth embodiment, the fixing member 28 is provided on the outer surface 55 of the shaft member 23. The fixing member 28 is configured to be capable of switching the distal end 29 of the long member 2 to a fixed state (a state ST2 in FIG. 8) in which the fixing member 28 moves to a position where the distal end 29 of the long member 2 is sandwiched by a pair of the fixing member 28 and the shaft member 23 and fixes the distal end 29 and a released state (a state ST1 in FIG. 8) in which the fixing member 28 moves in a direction separating from the sandwiching position and releases the fixing of the distal end 29 of the long member 2.

In the present embodiment, the one end 56 of the fixing member 28 is attached to the outer surface 55 of the shaft member 23 as the turning fulcrum 57 by a hinge or the like. The fixing member 28 is configured to be switched to a fixed state (a state ST2 in FIG. 8) in which the distal end 29 is sandwiched and fixed between the outer surface 55 of the shaft member 23 and the fixing member 28 when the other end 58 of the fixing member 28 turns as the free end 59 and a released state (a state ST1 in FIG. 8) in which the other end 58 turns in the opposite direction to release the distal end 29.

Here, the turning of the fixing member 28 in the direction of switching to the fixed state (the state ST2 in FIG. 8) is manually performed. Note that an electric turning structure using a solenoid or the like may be adopted rather than manually turning the fixing member 28.

### Explanation of effects of the sixth embodiment

(1) In the present embodiment, the fixing member 28 is configured to be capable of switching the distal end 29 of the long member 2 to the fixed state (the state ST2 in FIG. 8) in which the fixing member 28 moves to the position where the distal end 29 of the long member 2 is sandwiched by the pair of the fixing member 28 and the shaft member 23 and fixes the distal end 29 and the released state (the state ST1 in FIG. 8) in which the fixing member 28 moves from the sandwiching position and releases the fixing of the distal end 29 of the long member 2.

Accordingly, it is possible to fix and release the distal end 29 of the long member 2 by moving the fixing member 28 to the sandwiching position or moving the fixing member 28 in a direction of retracting from the sandwiching position.

(2) In the present embodiment, the one end 56 of the fixing member 28 is attached to the shaft member 23 as the turning fulcrum 57. Further, the fixing member 28 is configured to be switched to the fixed state and the released state when the other end 58 turns as the free end 59.

Accordingly, it is possible to fix and release the distal end 29 of the long member 2 with a simple structure of turning the fixing member 28 with the one end 56 as the turning fulcrum 57.

### Seventh Embodiment

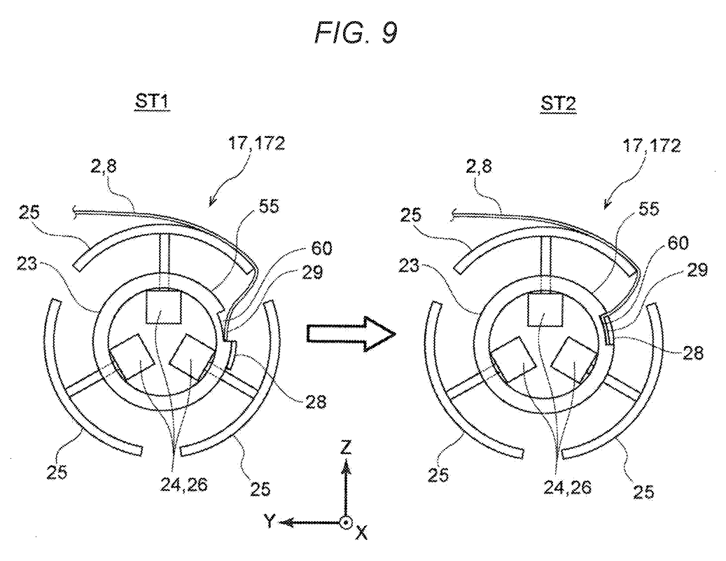

Subsequently, the support member winding device 172 according to a seventh embodiment is explained with reference to FIG. 9. The same portions as the portions of the first embodiment and the like are denoted by the same reference numerals and signs and explanation of configurations of the portions and effects corresponding to the configurations is omitted.

In the present embodiment, unlike the sixth embodiment, a recess 60 in which the fixing member 28 detachably fits is provided in the shaft member 23. The fixing member 28 is configured to be switched to a fixed state (a state ST2 in FIG. 9) in which the fixing member 28 moves to a position for fitting in the recess 60 and is fixed and a released state (a state ST1 in FIG. 9) in which the fixing member 28 moves in a direction of separating from the fitting position to release the fixing of the distal end 29 of the long member 2.

The fixing member 28 is locked to a not-illustrated locking section of the outer surface 55 of the shaft member 23 when being in the released state (the state ST1 in FIG. 9). Here, the movement of the fixing member 28 between the position in the fixed state (the state ST2 in FIG. 9) and the position of the released state (the state ST1 in FIG. 9) is manually performed. Note that an electric moving structure using a solenoid or the like may be adopted rather than manually moving the fixing member 28.

In the present embodiment, the fixing member 28 is configured to be switched to the fixed state (the state ST2 in FIG. 9) in which the fixing member 28 moves to the position for fitting in the recess 60 and is fixed and the released state (the state ST1 in FIG. 9) in which the fixing member 28 moves in the direction of separating from the fitting position to release the fixing of the distal end 29 of the long member 2.

Accordingly, by moving the fixing member 28 to the position for fitting in the recess 60 or moving the fixing member 28 in the direction of retracting from the fitting position, it is possible to fix and release the distal end 29 of the long member 2.

### Other embodiments

The winding device 17 and the recording apparatus 1 according to the present disclosure are based on the configurations of the embodiments explained above. However, it is naturally possible to, for example, change or omit a partial configuration without departing from the gist of the present disclosure.

(1) In the embodiments explained above, a case in which the present disclosure is applied to one support member winding device 172 of the winding device 17 is explained. However, the present disclosure may be applied to the other fabric winding device 171 or may be applied to both of the support member winding device 172 and the fabric winding device 171.

(2) In the embodiments explained above, the outer circumferential member 25 and the fixing member 28 are explained as being respectively disposed in the plurality of regions in the axial direction of the shaft member 23 (the X-axis direction). However, the outer circumferential member 25 and the fixing member 28 are not limited to this structure. That is, the outer circumferential member 25 and the fixing member 28 may have a single structure in which the outer circumferential member 25 and the fixing member 28 are disposed in a single region rather than a divided structure in which the outer circumferential member 25 and the fixing member 28 are divided and disposed in the plurality of regions.

(3) In the embodiments explained above, the outer circumferential member 25 and the fixing member 28 are explained as being respectively disposed in the plurality of regions in the axial direction of the shaft member 23 (the X-axis direction) and the outer circumferential member 25 disposed in the first region A1 and the outer circumferential member 25 disposed in the second region A2 are explained as being disposed in a staggered manner not to overlap in the circumferential direction (the same direction as the axial rotation CD) of the shaft member 23. However, it goes without saying that the outer circumferential members 25 are not limited to the staggered disposition. The outer circumferential member 25 disposed in the first region A1 and the outer circumferential member 25 disposed in the second region A2 may be disposed at the same position in the circumferential direction (the same direction as the axial rotation CD) of the shaft member 23. By disposing the outer circumferential members 25 at the same position, the fixed position 71 and the fixed position 72 are disposed at the same position in the circumferential direction. Therefore, work of sandwiching and fixing the distal end 29 of the long member 2 with the fixing member 28 is facilitated because the slitting and cutting processing is unnecessary.

What is claimed is:

1. A winding device comprising:
a rotating shaft member;
a plurality of first displacement units having one ends attached to the shaft member and capable of changing length in a radial direction of the shaft member; and
an outer circumferential member attached to other ends of the plurality of first displacement units, a long member being wound onto the outer circumferential member.

2. The winding device according to claim 1, further comprising a fixing member capable of switching a fixed state in which a distal end of the long member is fixed and a released state in which the distal end is released.

3. The winding device according to claim 2, further comprising a second displacement unit disposed between the plurality of first displacement units in a circumferential direction of the shaft member, having one end attached to the shaft member, and capable of changing length in the radial direction of the shaft member, wherein
the fixing member is attached to another end of the second displacement unit and sandwiches and fixes the distal end of the long member with a pair of the fixing member and the outer circumferential member when length in the radial direction of the second displacement unit is changed and the fixing member approaches the outer circumferential member.

4. The winding device according to claim 3, wherein the fixing member sandwiches and fixes the distal end of the long member with the pair of the fixing member and the outer circumferential member by, when the length in the radial direction of the second displacement unit is changed, being displaced to a same position as a position where the long member is wound onto the outer circumferential member in the radial direction.

5. The winding device according to claim 3, wherein the fixing member sandwiches and fixes the distal end of the long member with the pair of the fixing member and the outer circumferential member by, when the length in the radial direction of the second displacement unit is changed, being displaced to a position further on an inner side than a position where the long member is wound onto the outer circumferential member in the radial direction.

6. The winding device according to claim 2, wherein
the outer circumferential members adjacent to each other in a circumferential direction of the shaft member are a first outer circumferential member and a second outer circumferential member, and
the fixing member is provided in the first outer circumferential member and is capable of switching the distal end of the long member to a fixed state in which the fixing member comes into contact with the second outer circumferential member to sandwich and fix the distal end of the long member with a pair of the fixing member and the second outer circumferential member and a released state in which the fixing member separates from the second outer circumferential member to release the fixing of the distal end of the long member.

7. The winding device according to claim 6, wherein the fixed state and the released state of the fixing member are switched when one end of the fixing member is attached to the first outer circumferential member as a turning fulcrum and another end turns as a free end.

8. The winding device according to claim 6, wherein
the fixing member has one end attached to the first outer circumferential member and another end including a facing section facing an inner surface of the second outer circumferential member and is switched from the released state to the fixed state by increasing length in the radial direction of the first displacement unit, to which the first outer circumferential member is attached, and bringing the facing section close to the inner surface of the second outer circumferential member in a state in which length in the radial direction of the first displacement unit, to which the second outer circumferential member is attached, is increased.

9. The winding device according to claim 2, further comprising a second displacement unit disposed between the plurality of first displacement units in a circumferential direction of the shaft member, having one end attached to the shaft member and another end attached to the fixing member, and capable of changing length in the radial direction of the shaft member, wherein
the fixing member sandwiches and fixes the distal end of the long member with a pair of the fixing member and the shaft member when the length in the radial direction of the second displacement unit is changed and the fixing member approaches the shaft member.

10. The winding device according to claim 2, wherein the fixing member is capable of switching the distal end of the long member to a fixed state in which the fixing member moves to a position where the distal end of the long member is sandwiched by a pair of the fixing member and the shaft member and fixes the distal end of the long member and a released state in which the fixing member moves from the sandwiching position to release the fixing of the distal end of the long member.

11. The winding device according to claim 10, wherein the fixing member is switched to the fixed state and the released state when one end of the fixing member is attached to the shaft member as a turning fulcrum and the other end of the fixing member turns as a free end.

12. The winding device according to claim 10, wherein
a recess in which the fixing member detachably fits is provided in the shaft member, and
the fixing member is switched to the fixed state in which the fixing member moves to a position of fitting in the recess and is fixed and the released state in which the fixing member moves from the fitting position and releases the fixing of the distal end of the long member.

13. The winding device according to claim 3, wherein the outer circumferential member is in a point contact state or a line contact state with the long member to be wound onto the outer circumferential member.

14. The winding device according to claim 9, wherein the outer circumferential member is in a point contact state or a line contact state with the long member to be wound onto the outer circumferential member.

15. The winding device according to claim 2, wherein the outer circumferential member and the fixing member are respectively disposed in a plurality of regions in an axial direction of the shaft member.

16. The winding device according to claim 15, wherein the outer circumferential member disposed in a first region of the plurality of regions and the outer circumferential member disposed in a second region adjacent to the first region in the axial direction of the shaft member do not overlap in a circumferential direction of the shaft member.

17. A recording apparatus comprising:
a letting-out unit configured to let out a long member wound in a roll shape in a conveyance direction;
a recording unit configured to perform recording on the long member; and
a winding device located further downstream than the recording unit in the conveyance direction and configured to wind the long member, wherein
the winding device is the winding device according to claim 1.

18. A recording apparatus comprising:
a letting-out unit configured to let out a long member wound in a roll shape in a conveyance direction;
a recording unit configured to perform recording on the long member; and
a winding device located further downstream than the recording unit in the conveyance direction and configured to wind the long member, wherein
the letting-out unit lets out, in the conveyance direction, a roll-shaped long member formed by fabric being stuck to a support member having an adhesive surface,
the winding device includes a support member winding device and a fabric winding unit that peel off the fabric from the support member and respectively wind the fabric, and
at least the support member winding device includes:
a rotating shaft member;
a plurality of first displacement units having one ends attached to the shaft member and capable of changing length in a radial direction of the shaft member; and
an outer circumferential member attached to other ends of the plurality of first displacement units, the long member being wound onto the outer circumferential member.
